(19) United States
(12) Patent Application Publication
(10) Pub. No.: US 2026/0070762 A1
(43) Pub. Date: Mar. 12, 2026

(54) Chain Jam Detection Device

(71) Applicant: Columbus McKinnon Corporation, Getzville, NY (US)

(72) Inventor: Jared Benjamin Godbey, Meadowview, VA (US)

(21) Appl. No.: 18/882,844

(22) Filed: Sep. 12, 2024

(51) Int. Cl. B66D 1/36; B66D 1/54

(52) U.S. Cl. CPC B66D 1/36; B66D 1/54

(57) ABSTRACT

A chain jam detection device for use with a hoist having a chain. The chain jam detection device includes a hoist frame with a chain guide subsystem pivotally mounted on the hoist frame. The chain guide subsystem has a housing enclosing a lift wheel for conveying the chain. The lift wheel is configured to rotate about a lift wheel axis. A chain detangler mounted on the chain guide subsystem is configured to guide the chain into and out of the chain guide subsystem. A biasing member is supported by the hoist frame. The device is configured such that force of the chain against the chain detangler when a chain link is misaligned causes the chain guide subsystem to rotate relative to the hoist frame. A sensor is configured to detect rotation of the chain guide subsystem relative to the hoist frame. The biasing member engages with the chain guide subsystem to provide a rotational torque limiting device, and the sensor causes power to the hoist to be shut off when a predetermined threshold for torque is exceeded.

### TECHNICAL FIELD

The present invention relates generally to the field of material handling devices, and more particularly to a device for detecting a chain jam in a hoist of the type typically used for rigging applications in the entertainment industry.

### BACKGROUND ART

Hoists used in the entertainment industry are typically stored in road cases with large amounts of load chain. When the hoist is stowed, it is generally in the inverted position (top hook toward the bottom of the road case) which can lead to large amounts of load chain piling on top of the chain entry/exit points. When chain runs in and out of a hoist, it must be oriented correctly or damage to the chain and/or unit will result. Most hoists in the market today are sold with a chain detangling feature designed to untwist the load chain as it enters the unit to prevent damage. While this feature typically works well, an excessive amount of load chain piled on the unit prevents the chain from being able to untwist as it is pulled into the unit. This configuration can result in a “knot” of chain being pulled into the body of the hoist which causes the overload clutch to activate. Even if the overload clutch is slipping, damage to the hoist frames and detangler can result. Additionally, there is a common practice in the entertainment industry to activate a unit by some other means than depressing the up/down control buttons. This practice allows the operator to walk away from the unit during operation. Consequently, if the slip clutch is activated due to a chain knot, the clutch will continue to slip until the operator returns. This extended amount of clutch slip can result in damage to the hoist. A safeguard may be provided for a hoist being operated in the inverted configuration by shutting down the unit if a predetermined force is exerted on the entry/exit ports of the hoist.

What is needed is an improved torque limiting device to prevent the system from shutting off power to the unit before a predetermined torque level is reached.

### BRIEF SUMMARY OF THE INVENTION

With parenthetical reference to the corresponding parts, portions or surfaces of the disclosed embodiment, merely for the purposes of illustration and not by way of limitation, the present invention provides a torque limiting device for use with a chain guide subsystem on a chain hoist.

The chain jam detection device is for use with a hoist (6) having a chain (49). The chain jam detection device includes a hoist frame (10). A chain guide subsystem (37) is pivotally mounted on the hoist frame (10). The chain guide subsystem (37) has a housing (52) enclosing a lift wheel (40) for conveying the chain (49). The lift wheel (40) is configured to rotate about a lift wheel axis (109).

A chain detangler (92) is mounted on the chain guide subsystem (37) and is configured to guide the chain (49) into and out of the chain guide subsystem (37).

A biasing member (74) is supported by the hoist frame (10).

The device is configured such that force of the chain (49) against the chain detangler (92) when a chain link is misaligned causes the chain guide subsystem (37) to rotate relative to the hoist frame (10).

A sensor (87) is configured to detect rotation of the chain guide subsystem (37) relative to the hoist frame (10).

The biasing member (74) engages with the chain guide subsystem (37) to provide a rotational torque limiting device.

The sensor (87) causes power to the hoist (6) to be shut off when predetermined conditions are met.

The system may further comprise the housing (52) on the chain guide subsystem (37) having a pair of slots (61, 64) for rotatably mounting the housing (52) on a pair of elongate members (67, 70).

In a further aspect, the biasing member (74) may comprise spring steel formed in the shape of a V.

In another aspect of the invention, rotation of the chain guide system (37) about the lift wheel axis (109) causes actuation of a switch to open a circuit and turn off the hoist motor.

In another aspect, the sensor (87) comprises a load cell with a strain gauge.

In yet another aspect, the sensor (87) comprises a microswitch (89).

In another aspect of the invention, the housing (52) comprises a pair of housing members (55, 58) capable of attaching to form an enclosure for receiving the lift wheel (40).

In another aspect, the housing (52) has a groove (73) formed in a top surface (71) thereof.

In yet another aspect of the invention, the biasing member (74) is configured to engage with the groove (73) on the top surface (71) of the housing (52).

Another aspect of the invention is that the biasing member (74) is configured to engage the groove (73) to provide a rotational torque limiting device.

### BRIEF DESCRIPTION OF THE DRAWINGS

FIG. 1 is a perspective view of a hoist frame with a chain guide subsystem installed therein.

FIG. 2 is an exploded view of the hoist frame of FIG. 1.

FIG. 3 is an exploded view of the chain guide subsystem of the present invention.

FIG. 4 is a front elevational view showing the torque limiting device of the present invention.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

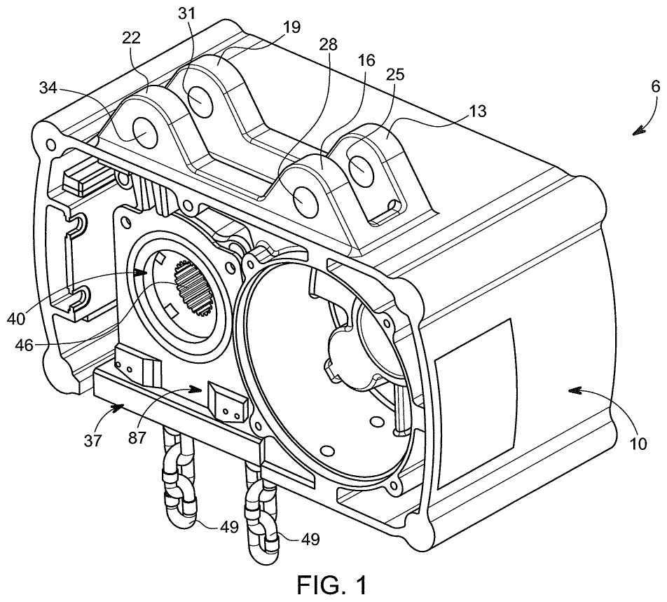

Referring now to the drawings, and more particularly to FIG. 1 thereof, this invention provides a hoist 6 having a hoist frame 10 may be supported from mounting tabs 13, 16, 19, and 22 having aligned openings 25, 28, 31, and 34.

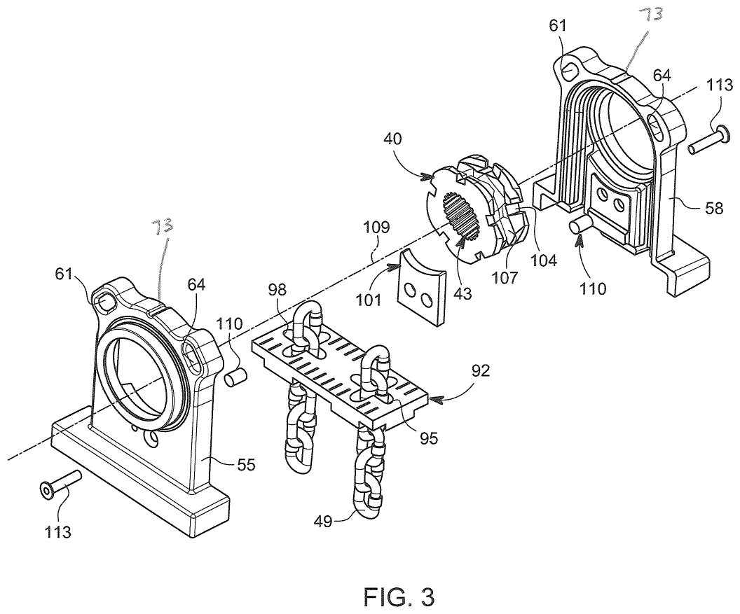

A chain guide subsystem 37 may be supported inside the hoist frame 10. The chain guide subsystem 37 may support a lift wheel 40 as will be described in greater detail below. The lift wheel 40 may be driven by a shaft (not shown). The shaft may be driven by a hoist motor (not shown). The lift wheel 40 may have a central opening 43 with splines 46 for engaging with the drive shaft. As shown in FIG. 3 and described herein below, the perimeter of the lift wheel 40 is configured with grooves designed to receive the links on a chain 49 such that the chain 49 is held in a specific orientation as it is driven by the lift wheel 40.

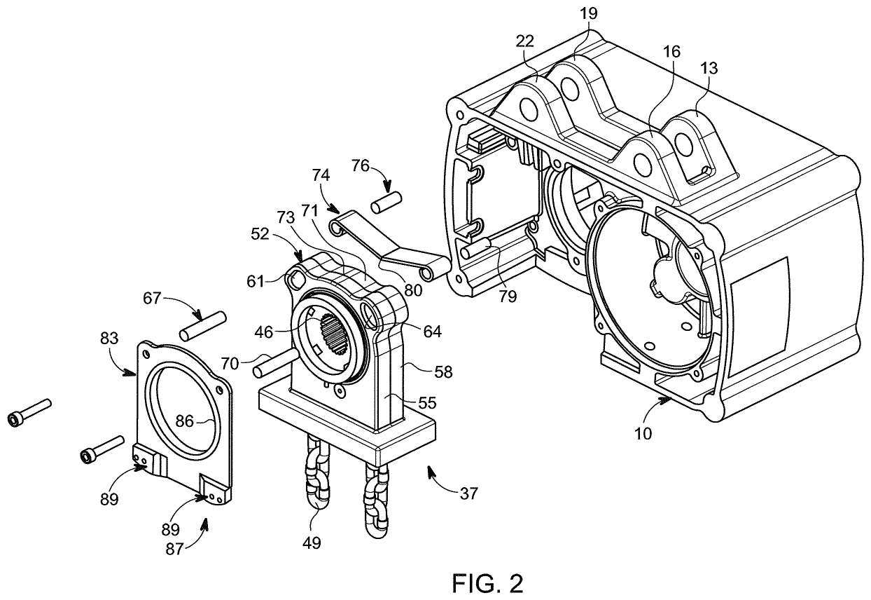

Turning to FIG. 2, the chain guide subsystem 37 may be provided with a housing 52 that may be comprised of two equal halves 55 and 58. The housing 52 may be provided with a pair of slots 61, 64 at each top corner. The slots 61, 64 may be oval shaped and elongate. The slots 61, 64 provide for pivotally mounting the chain guide subsystem 37 inside the hoist frame 10. The slots 61, 64 may receive elongate support members 67, 70 such as dowels. The elongate, oval shaped slots 61, 64 provide a range of motion such that the chain guide subsystem 37 is configured to rotate about a lift wheel axis relative to the hoist frame 10.

The housing 52 may be formed such that a groove 73 is defined in the top surface 71 of the housing 52 when the two halves 55, 58 are connected.

A biasing member 74 which may be constructed of a piece of spring steel having a V-shaped configuration may be supported inside the hoist frame 10 from a pair of elongate rods 76, 79 that may be in the form of dowels. The apex 80 of the V-shape engages with the groove 73 to provide a force to resist the rotation of the chain guide subsystem 37. The configuration of the V-shaped steel provides a torque limiting device to prevent “nuisance” trips as will be described in greater detail herein.

An outer carrier 83 with a bushing 86 may be provided with a sensor 87. The sensor may comprise a pair of micro switches 89. The micro switches 89 may detect rotation of the chain guide subsystem 37 as described in greater detail herein. Other sensors 87 such as load cells may also be suitable as will be evident to persons of ordinary skill in the art based on this disclosure.

Turning to FIG. 3, an exploded view of the chain guide subsystem 37 shows a detangler 92 having a pair of openings 95, 98 configured to position the chain in a specific orientation to prevent tangling. A chain stripper 101 is also provided to keep the chain 49 free of debris as it moves through the hoist system. Lift wheel 40 is configured with grooves 104, 107 to receive the links on the chain 40 to maintain position the chain 49 on the lift wheel 40. The central opening 43 on the lift wheel 40 is configured to receive a shaft (not shown). Accordingly, the lift wheel 40 may be rotated by the shaft driven by an electric motor. The lift wheel 40 rotates about an axis 109.

The two halves 55 and 58 of the housing 52 may be provided with studs 110 for alignment and may be attached by fasteners 113. The chain guide subsystem 37 is supported by elongate members 67, 70 (FIG. 2) fixedly attached to the hoist frame 10. The chain guide subsystem 37 is rotatably supported by the elongate members 67, 70 but biased against rotation by the biasing member 74 (FIG. 2).

The chain guide subsystem 37 is designed to rotate about the lift wheel axis 109. The chain detangler 92, as described above, is housed in the chain guide subsystem 37 through which the load chain 49 is pulled by the liftwheel 40. If a knot of chain or any foreign object strikes the chain detangler 92, that force is transmitted to the detangler 92 and then to the chain guide subsystem 37 thus forcing the chain guide subsystem 37 to rotate about the lift wheel axis 109 by the lifting/lowering motion of the chain 49. As the chain guide subsystem 37 is rotating, the subsystem 37 engages a sensor such as a force measuring device (load cell, feature with strain gauges installed) or micro switches 89 which, depending on the amount of force detected by the sensor, may cause a circuit to open and kill the power to the hoist motor.

The chain guide subsystem 37 is provided with a rotational torque limiting device. Under normal operation conditions, interactions between the chain, liftwheel, and chain detangler 92 will occur resulting in natural rotational movements of the chain guide subsystem 37. To prevent nuisance trips based on natural movements, a torque limiting device is used to prevent rotation of the chain guide subsystem until a predetermined level of torque has been reached. In this manner the rotation based on natural rotation movements is screened out and rotation based on conditions such as a chain jam trigger the sensor to shut off power to the hoist motor.

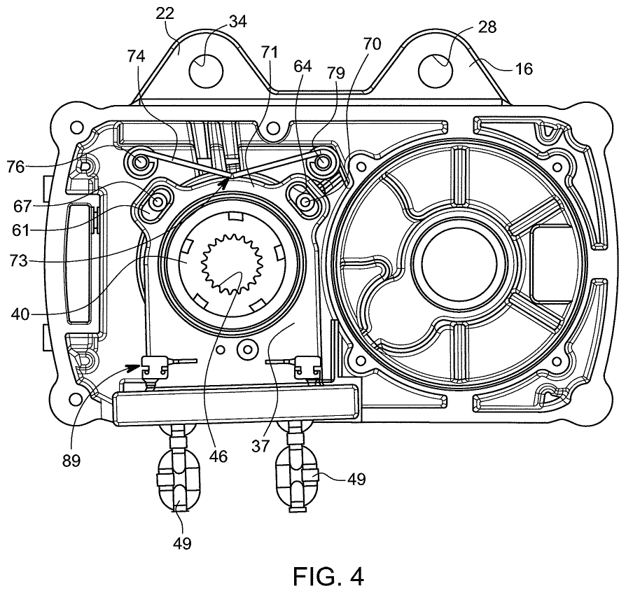

Turning to FIG. 4, a cross-sectional view of the housing 52 is provided with some of the parts removed for clarity. As shown, the biasing member 74 which may comprise a piece of spring steel with a V-shaped configuration with an apex 80. The biasing member 74 bears against a groove 73 in the top surface 71 of the housing 52 to provide a predetermined threshold preventing rotation of the chain guide subsystem 37 about the lift wheel axis 109. When the force of the chain 49 against the detangler 92 is sufficient to cause enough torque to overcome the force of the biasing member such that the apex 80 is pushed out of the groove 73, the chain guide subsystem 37 rotates about the lift wheel axis 109 such that the sensor 87 is tripped which causes a circuit to open killing the power to the hoist motor. The biasing member 74 is supported by members 76 and 79 (extending normal to the page) attached to the hoist frame 10. The chain guide subsystem 37 is supported by members 67 and 70 (extending normal to the page) and rotates about the liftwheel axis 109 in the slots 61 and 64.

The present invention contemplates that many changes and modifications may be made. Therefore, while the presently-preferred form of the chain jam detection device has been shown and described, and several modifications and alternatives discussed, persons skilled in this art will readily appreciate that various additional changes and modifications may be made without departing from the spirit of the invention, as defined and differentiated by the following claims.

1. A chain jam detection device for use with a hoist having a chain, the chain jam detection device, comprising:
a hoist frame;
a chain guide subsystem pivotally mounted on the hoist frame, the chain guide subsystem having a housing enclosing a lift wheel for conveying the chain, the lift wheel configured to rotate about a lift wheel axis;
a chain detangler mounted on the chain guide subsystem and configured to guide the chain into and out of the chain guide subsystem;
a biasing member supported by the hoist frame;
wherein the device is configured such that force of the chain against the chain detangler when a chain link is misaligned causes the chain guide subsystem to rotate relative to the hoist frame;
a sensor configured to detect rotation of the chain guide subsystem relative to the hoist frame;
wherein the biasing member engages with the chain guide subsystem to provide a rotational torque limiting device; and,
wherein the sensor causes power to the hoist to be shut off when predetermined conditions are met.

2. The device of claim 1, wherein the housing on the chain guide subsystem has a pair of slots for rotatably mounting the housing on a pair of elongate members.

3. The device of claim 1, wherein the biasing member is spring steel formed in the shape of a V.

4. The device of claim 1, wherein rotation of the chain guide system about the lift wheel axis causes actuation of a switch to open a circuit and turn off the hoist motor.

5. The device of claim 1, wherein the sensor comprises a load cell with a strain gauge.

6. The device of claim 1, wherein the sensor comprises a microswitch.

7. The device of claim 1, wherein the housing comprises a pair of housing members capable of attaching to form an enclosure for receiving the lift wheel.

8. The device of claim 1, wherein the housing has a groove formed in an exterior surface surface thereof.

9. The device of claim 8, wherein the biasing member is configured to engage with the groove on the housing.

10. The device of claim 9, wherein the biasing member is configured to engage the groove to provide a rotational torque limiting device

11. A chain jam detection device for use with a hoist having a chain, the chain jam detection device, comprising:
a hoist frame;
a chain guide subsystem pivotally mounted on the hoist frame, the chain guide subsystem having a housing enclosing a lift wheel for conveying the chain, the lift wheel configured to rotate about a lift wheel axis;
a chain detangler mounted on the chain guide subsystem and configured to guide the chain into and out of the chain guide subsystem in a predetermined configuration;
a biasing member supported by the hoist frame;
wherein the device is configured such that force of the chain against the chain detangler when a chain link is misaligned causes the chain guide subsystem to rotate about a lift wheel axis relative to the hoist frame;
a sensor configured to detect rotation of the chain guide subsystem about the lift wheel axis relative to the hoist frame;
wherein the biasing member engages with the chain guide subsystem to provide a rotational torque limiting device; and,
wherein the sensor causes power to the hoist to be shut off when the torque on the chain guide subsystem exceeds a threshold set by the biasing member.

12. The device of claim 11, wherein the housing on the chain guide subsystem has a pair of slots for rotatably mounting the housing on a pair of elongate members.

13. The device of claim 11, wherein the biasing member is spring steel formed in the shape of a V.

14. The device of claim 11, wherein rotation of the chain guide system about the lift wheel axis causes actuation of a switch to open a circuit and turn off the hoist motor.

15. The device of claim 11, wherein the sensor comprises a load cell with a strain gauge.

16. The device of claim 11, wherein the sensor comprises a microswitch.

17. The device of claim 11, wherein the housing comprises a pair of housing members capable of attaching to form an enclosure for receiving the lift wheel.

18. The device of claim 11, wherein the housing has a groove formed in an exterior surface thereof.

19. The device of claim 18, wherein the biasing member is configured to engage with the groove on the housing.

20. The device of claim 19, wherein the biasing member is configured to engage the groove to provide a rotational torque limiting device.
